(19) United States
(12) Patent Application Publication
(10) Pub. No.: US 2013/0275524 A1
(43) Pub. Date: Oct. 17, 2013

(54) Time Sensitive Audio and Text Feedback Process for a Prioritized Media Rich Digital Messaging System

(71) Applicants: Timothy Gueramy, Austin, TX (US); Tracey Haas, Austin, TX (US)

(72) Inventors: Timothy Gueramy, Austin, TX (US); Tracey Haas, Austin, TX (US)

(21) Appl. No.: 13/649,566

(22) Filed: Oct. 11, 2012

Related U.S. Application Data
(60) Provisional application No. 61/545,855, filed on Oct. 11, 2011.

(51) Int. Cl. H04L 12/58

(52) U.S. Cl. CPC H04L 51/26
USPC 709/206

(57) ABSTRACT

This invention relates to a messaging priority system that allows for a rich-media digital message sent over an electronic media to an intended recipient to be prioritized over several levels. Each level corresponds to a time limit. If the message does not reach or is not viewed by the intended recipient within the selected level's time limit, a notification is sent to the sender informing that the message was not viewed within the time limit. The rich-media digital message includes text, images, video and audio all sent over electronic media including email, text, instant message, and the like. The notification back to the sender that the message was unread in the allotted time is a dual notification that includes both text and audio.

### RELATED APPLICATION

This application claims the benefit of U.S. Provisional Application No. 61/545,855, filed Oct. 11, 2011.

### BACKGROUND OF THE INVENTION

1. Field of the Invention

This invention relates to a messaging priority system that allows for a rich-media digital message sent over an electronic media to an intended recipient to be prioritized over several levels that each correspond to a time limit wherein if the message does not reach or is not viewed by the intended recipient within the selected level's time limit, a notification is sent to the sender informing that the message was not viewed within the time limit.

2. Description of Related Art

In the medical community, some roles require critical collaborative work between cross-functional professionals and involve time-sensitive communications. Effective, timely communications between physicians, medical technicians, and the like can be necessary in certain situations for providing the patient with the needed and correct medical treatment. When critical collaborative work between medical professionals is needed, it is imperative that the sender of the message knows whether the intended recipient has received the message within a pre-determined time.

Certain prior art messaging systems teach that if a message with time-sensitive information is not received by a recipient within a set time period, that the message is either changed with updated information or deleted from the recipient's inbox. This messaging feature works well in certain situations, such as when a store is emailing its customers about a one-day sale for example. If the customer does not open the message before the conclusion of the sale, then the email would automatically change to announce the next one-day sale or would be deleted completely. This would ensure that the customer does not get out of date information from the store. However, in these prior art messaging systems the sender of the message does not receive any notification as to whether the intended recipient opened the message in the allotted time.

It is therefore desirable to have a message priority system in which the sender of the message is notified at the expiration of the time period if the recipient has not received the message. Furthermore, it is desirable to have a message priority system in which the sender can select the time period for a response based upon the time-sensitive urgency of the message being sent.

### SUMMARY OF THE INVENTION

The present invention provides generally for a messaging priority system that allows for a rich-media digital message sent over an electronic media to an intended recipient to be prioritized over several time limit levels. Messaging priority is the ability to attach a time sensitive notification to an outgoing mobile message (including email, text, instant message, etc.) wherein if the recipient of the message does not receive and open the message within the selected time frame, a message is returned to the sender that the message has not been read. The sender has the ability to set the time sensitivity of the message (e.g. 5 minutes, 15 minutes, 1 hour, etc.) and would receive a notification back if the message had not been received and opened by the recipient in the selected allotted time.

Preferably this message priority system is used in the medical profession to aid in the collaborative communication between medical professions in situations where time-sensitive communications are necessary. Timely communication and the knowledge of whether a message has reached an intended recipient ensure smooth and efficient work flows in several critical professional services. Additionally, one can avoid wasting time waiting for responses to messages that have not yet been read and instead focus on taking remedial measures. For example, a doctor could send a picture of a patient's x-ray to a more specialized doctor for a second opinion on a diagnosis and proposed treatment plan. The sending doctor needs to know if the recipient doctor has reviewed the x-ray within the selected time frame (e.g., 15 minutes) so that he does not keep the patient waiting and can move forward with the treatment. The time limit can be selected based on the time-sensitivity of the situation wherein a short time limit is set for urgently critical matters and a longer time limit is set for less critical matters.

In a preferred embodiment, the message priority system allows the user of the system to prepare a message to be sent. The message could take any rich-media digital form including text, image, video or audio. The user also selects the recipient or recipients for whom the message is intended. Next, the user is prompted to enter the priority level of the message. Priority level 1 corresponds to time limit 1 (e.g., 5 minutes), priority level 2 corresponds to time limit 2 (e.g., 15 minutes) and so forth. Alternatively, the user is asked to enter the desired time limit for the message.

The novel features and construction of the present invention, as well as additional objects thereof, will be understood more fully from the following description when read in connection with the accompanying drawings.

### BRIEF DESCRIPTION OF THE DRAWINGS

The improved process of the invention is further described and explained in relation to the following figures of the drawings wherein:

FIG. 1 is an illustration of a typical Internet Service Provider (ISP) network.

FIG. 2 is a logic flow diagram for a messaging priority system.

FIG. 3 is a diagram showing how the various priority levels operate in a preferred embodiment of the messaging priority system

Like reference numerals are used to describe like parts in all figures of the drawings.

### DESCRIPTION OF THE PREFERRED EMBODIMENTS

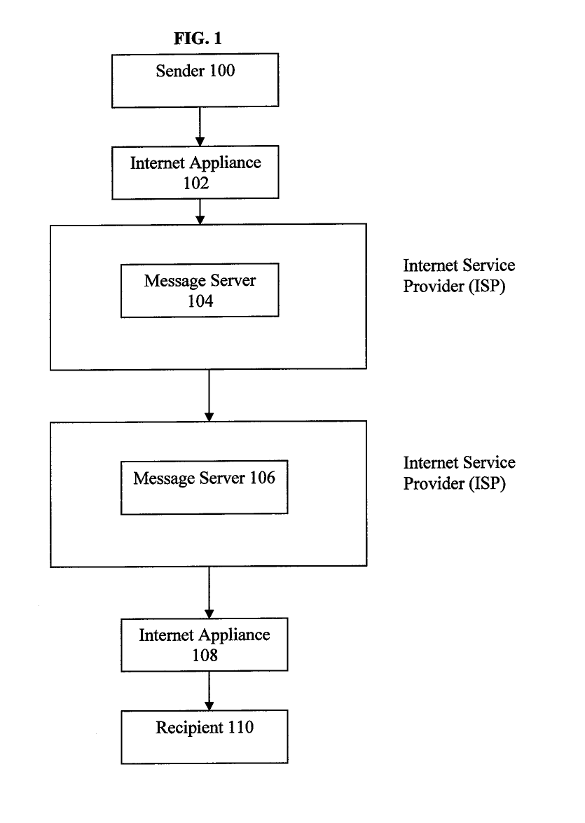

Referring to FIG. 1, a typical Internet Service Provider (ISP) network is shown according to an embodiment of the present invention. It is shown with two ISPs, but it should be understood that the systems described may be used with just one ISP or multiple ISPs. Sender 100 creates a mail message on his Internet appliance 102. The message could take any rich-media digital form including text, image, video or audio. Sender 100 also selects recipient 110 or recipients for whom the message is intended. Internet appliance 102 could be any device that is capable of sending and receiving email messages, such as a web-enabled cell phone, a Blackberry®, a personal digital assistant (PDA), laptop or desktop computer, or the like. The message is sent to sender's ISP where it reaches message server 104. The message is then sent to recipient's ISP where it reaches message server 106. From there the message reaches recipient's internet appliance 108, where recipient 110 can view.

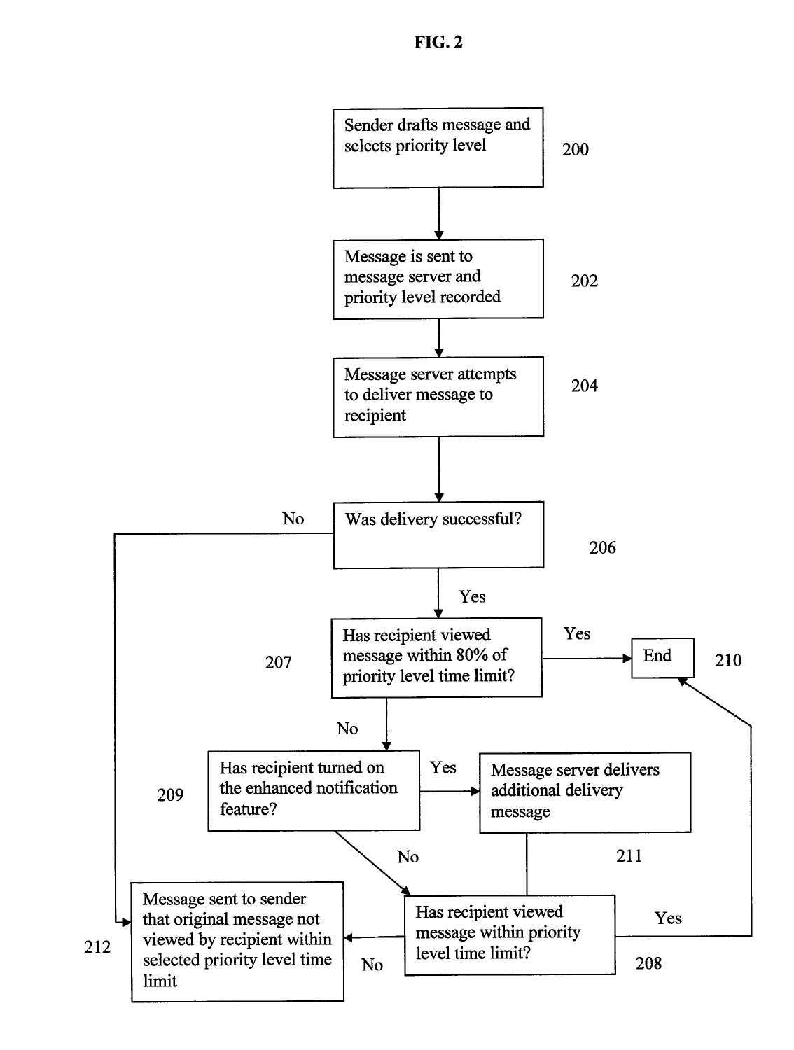

Referring to FIG. 2, a logic flow diagram of the messaging priority system is shown in which a routine is shown for sending a message with a selected priority level. The routine begins at 200 in which the sender drafts his intended message and selects the priority level. The sender selects his priority level based on the time-sensitivity of the message and how quickly he needs a response before the information would otherwise be out-dated or unhelpful. In step 202, the message is sent to the message server and the priority level is recorded. In step 204, the message server attempts to deliver the message to the recipient. Step 206 is a determination as to whether the attempted delivery of the message was successful. If the delivery was successful, then the routine proceeds to step 207. If the delivery was not successful, then the routine proceeds to step 212 in which the sender is notified that his message did not reach the desired recipient.

Steps 207, 209 and 211 show an optional feature of the preferred embodiment in which an enhanced notification function is utilized. The enhanced notification function is a function that the recipient pre-selected when he or she signed up for the messaging priority system. Step 207 is a determination as to whether the recipient has viewed the message within 80% of the time limit allowed by the selected priority level. For example, if the sender selects a time limit of ten minutes, then step 207 would determine whether the recipient has viewed the message after the lapse of eight minutes after the message was sent. If the recipient has viewed the message, then the routine ends at step 210, and no notification is sent to sender. If the recipient has not viewed the message in the time period, then at step 209, a determination is made as to whether the recipient has previously turned on the enhanced notification feature. If the recipient has not turned on the enhanced notification feature, then nothing occurs until step 208. If the recipient has turned on the enhanced notification feature, at step 211 the message serve delivers an additional message, which is preferably a text and/or email message. After the delivery of the additional message, the process moves forward to step 208.

Step 208 is a determination as to whether the intended recipient has viewed the message with the time limit allowed by the selected priority level. If the sender selects a priority level with a time limit of ten minutes for example, then step 208 determines whether the recipient has viewed the message within 10 minutes from when the sender sent the message. If the recipient has viewed the message, then the routine ends at step 210, and no notification is sent to sender. If the recipient has not viewed the message in the time period, then at step 212, the sender is notified of such.

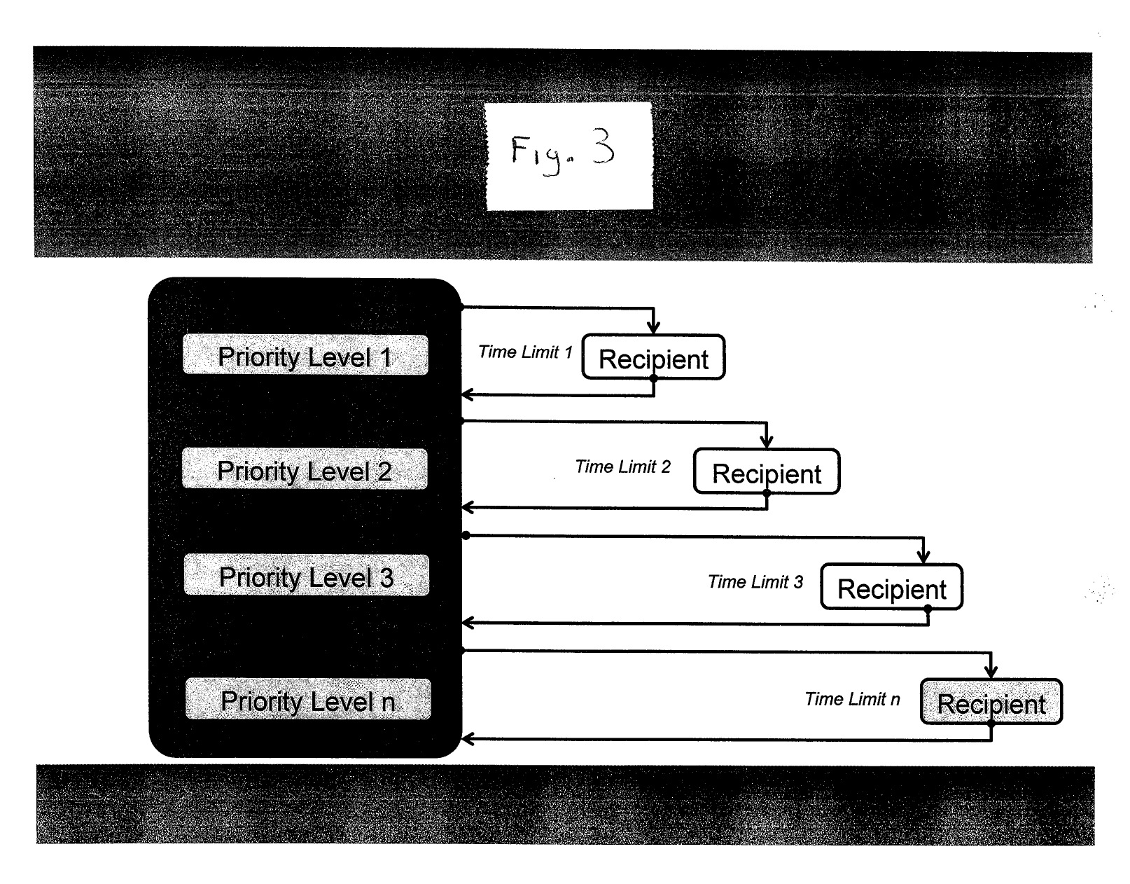

Referring to FIG. 3, a diagram showing the different priority levels is shown. Each priority level is associated with a prescribed time, and the sender selects the appropriate time limit based on the time sensitivity of the message. Priority level 1 is the most time-sensitive and would have the shortest time limit. Priority level 2 would be next and then followed by priority level 3. It is understood that based on the nature of the work the user performs, as many different priority levels as desired could be set. It is also understood that the user would have the option to pick his own time limit.

Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

1. A messaging priority system that provides electronic notification to an intended recipient comprising:
an internet appliance configured to allow drafting of a message by an originator including entry of a desired recipient and input of a time priority level corresponding to a viewing time limit;
a message server that receives the message from the originator's internet appliance, records the time priority level and delivers the message to an internet appliance of the recipient;
wherein the messaging server determines whether the recipient has viewed the message within the selected time priority level and notifies the originator if the recipient has not viewed the message within the selected time priority level.

2. The messaging priority system of claim 1 further comprising an enhanced notification feature in which the messaging server determines whether the recipient has viewed the message within a viewing time limit that is smaller than the selected time priority level and delivers an additional message to the recipient if the original message has not yet been viewed by the recipient.

3. The messaging priority system of claim 2 wherein the additional message is a text message to the recipient.

4. The messaging priority system of claim 2 wherein the additional message is an instant message to the recipient.

5. The messaging priority system of claim 2 wherein the additional message is an additional email.

6. The messaging priority system of claim 1 wherein the time priority level is chosen from a menu offering choices from around 5 minutes to around 15 minutes.

7. The messaging priority system of claim 1 wherein the originator is allowed to set the time priority level to any value.
